(19) United States
(12) Patent Application Publication
(10) Pub. No.: US 2003/0001291 A1
(43) Pub. Date: Jan. 2, 2003

(54) Apparatus and method for preventing growth of marine organisms

(76) Inventor: John Walter Stevens, Fairhope, AL (US)

Correspondence Address: George L. Williamson, P.O. Box 508, Fairhope, AL, 36533, US

(21) Appl. No.: 09/897,161

(22) Filed: Jul. 2, 2001

(51) Int. Cl. B01F 3/04

(52) U.S. Cl. 261/77; 261/124; 210/221.2

(57) ABSTRACT

The present invention discloses a system for preventing the growth of marine organisms on objects which are continually submerged in water, such as a boat hull or piling. The present invention operates by having a source of air deliver air through a conduit to an underwater aeration device placed in proximity to the object which is desired to be free of the marine organisms. The present invention comprises an underwater aeration framework having a plurality of air vents therein which supply air bubbles so as to constantly keep the water in motion around the boat hull, piling or other underwater structure, thereby preventing the growth of marine flora and fauna.

### BACKGROUND OF THE INVENTION

1. Field of the Invention

The present invention generally relates to aeration devices and, more particularly is concerned with an aeration system for preventing the growth of marine organisms on underwater structures.

2. Description of the Prior Art

It is known in the art that marine organisms will not grow on underwater structures if the water around the structure is in motion. A patent search has found no prior art useful for this purpose. However, the search did reveal an aeration device as described below. However, this prior art device does not disclose the unique features of the present invention.

In U.S. Pat. No. 3,814,399, dated Jun. 4, 1974, Melreit disclosed a device for aerating water in a bathtub by a flow of heated air supplied to the device from a remote source. The device comprises a generally oval flat bottom base with a top section permanently attached thereto. The top section is formed with an inverted outer U-shaped channel extending around the periphery of the top section and forming an air passage with the base. Another similarly shaped central channel extends from one end of the top section longitudinally along the top section forming another air passage. The channels are supplied with the heated air under pressure through a connected base, and the air then flows into the water through a plurality of spaced holes formed in the channels. An opening is formed in the outer channel to provide access into both outer and central channels for cleaning. A slip collar is mounted on the supply air hose coupling to permit regulation of the amount of water aeration. A seat is formed integrally on the top section to provide a conformable area upon which the bather may sit when using the device.

While this aeration system may be suitable for the purposes for which they were designed, they would not be as suitable for the purposes of the present invention, as hereinafter described.

### SUMMARY OF THE INVENTION

The present invention discloses a system for preventing the growth of marine organisms on objects which are continually submerged in water, such as a boat hull or piling. The present invention operates by having a source of air deliver air through a conduit to an underwater aeration device placed in proximity to the object which is desired to be free of the marine organisms. The present invention comprises an underwater aeration framework having a plurality of air vents therein which supply air bubbles so as to constantly keep the water in motion around the boat hull, piling or other underwater structure, thereby preventing the growth of marine flora and fauna.

An object of the present invention is to provide an underwater aeration device to be placed in proximity to underwater structures such as boat hulls, pilings and oilrig support members. A further object of the present invention is to prevent the growth of marine growth which might otherwise become attached to the underwater structure.

The foregoing and other objects and advantages will appear from the description to follow. In the description reference is made to the accompanying drawings, which form a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### BRIEF DESCRIPTION OF THE DRAWINGS

In order that the invention may be more fully understood, it will now be described, by way of example, with reference to the accompanying drawings in which:

FIG. 1 is a plan view of one embodiment of the present invention.

FIG. 2 is a plan view of one embodiment of the present invention.

FIG. 3 is an end elevation view of the present invention in operative connection.

FIG. 4 is a side elevation view of the present invention in operative connection.

FIG. 5 is an elevation view of one embodiment of the present invention in operative connection.

FIG. 6 is a plan view of one embodiment of the present invention in operative connection.

### LIST OF REFERENCE NUMERALS

With regard to reference numerals used, the following numbering is used throughout the drawings.

10 present invention

12 framework

14 air holes/aerators

16 air supply

18 conduit

20 means for connection

22 means for connection

24 electric cord

26 weights

28 vessel

30 water line

32 bed of water body

34 air bubbles

36 hull

38 piling

40 pier

### DESCRIPTION OF THE PREFERRED EMBODIMENT(S)

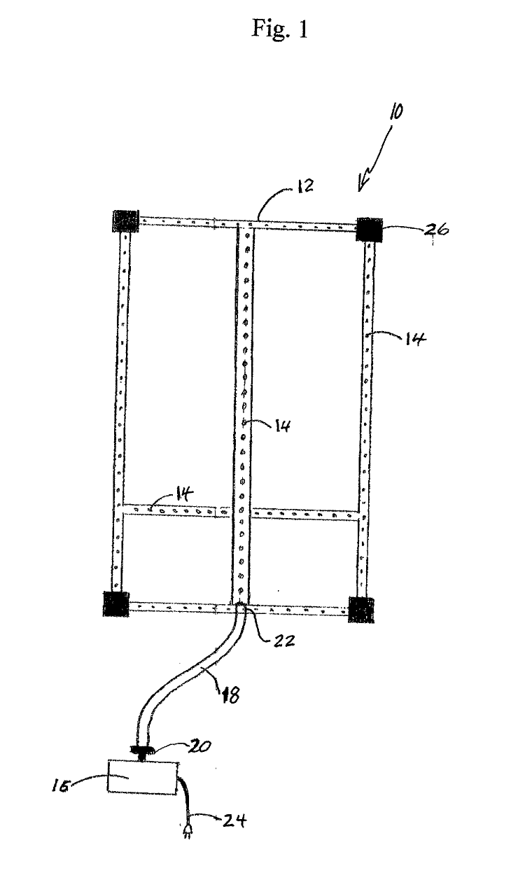

In order that the invention may be more fully understood, it will now be described, by way of example, with reference to the accompanying drawing in which FIGS. 1 through 6 illustrate the present invention wherein an aeration for the prevention of growth of marine organisms is disclosed.

Turning to FIG. 1, therein is shown a plan view of one embodiment of the present invention 10. Shown therein is a framework 12 made of polyvinyl chloride (PVC) or acrylonitrile butadiene styrene (ABS) tubing or the like which framework 12 is interconnected and is designed to be placed on the bottom of a lake, river or ocean proximate to an underwater structure. The framework 12 has a plurality of air holes 14 disposed therein being spaced apart throughout the framework 12 having an air supply means 16 which is electrically or gasoline powered. The air supply 16 is connected to the framework 12 through a conduit means 18 which could be flexible tubing of various types, which conduit 18 has means for a quick disconnect coupling 20 which connects into the air supply along with means for connection 22 for connecting the conduit to the framework 12. Also shown is an electrical cord 24 which is used to provide electricity to the electrical air supply means 16. Additionally, therein is shown means for weighting 26 the framework down to the ocean or water bed which in this case are a plurality of weights 26 placed about the framework 12 so as to anchor it to the bottom of the water basin. The embodiment of the present invention shown in FIG. 1 is designed for use inside a boat slip where full coverage of a boat hull or the like would be needed and can be placed under barges or floating oil rigs and is useful for water bodies having high current velocities.

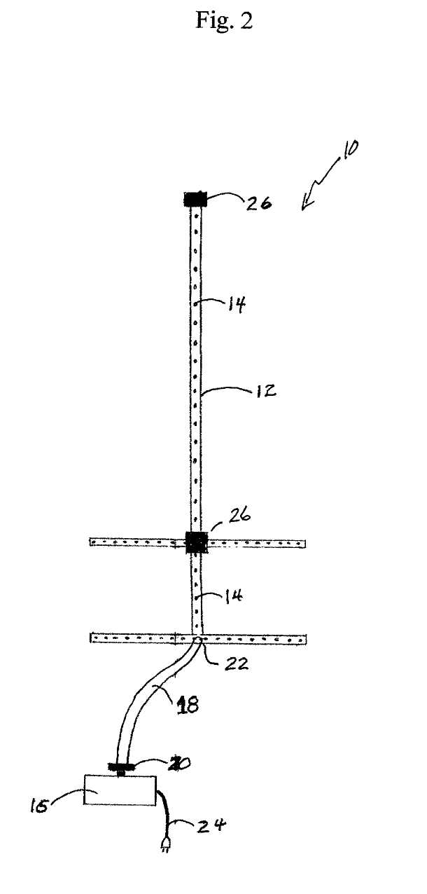

Turning to FIG. 2, shown therein is a plan view of one embodiment of the present invention 10. Shown therein is an embodiment of the present invention which is designed to be placed inside a single boat slip having the main longitudinal frame member running underneath the boat hull parallel to the keel of the hull of the vessel. Shown therein is the framework 12 having a plurality of air holes or aerators 14 therein being weighted down with weights 26 in order to keep the present invention onto the bottom of the body of water. Other elements previously disclosed are also shown.

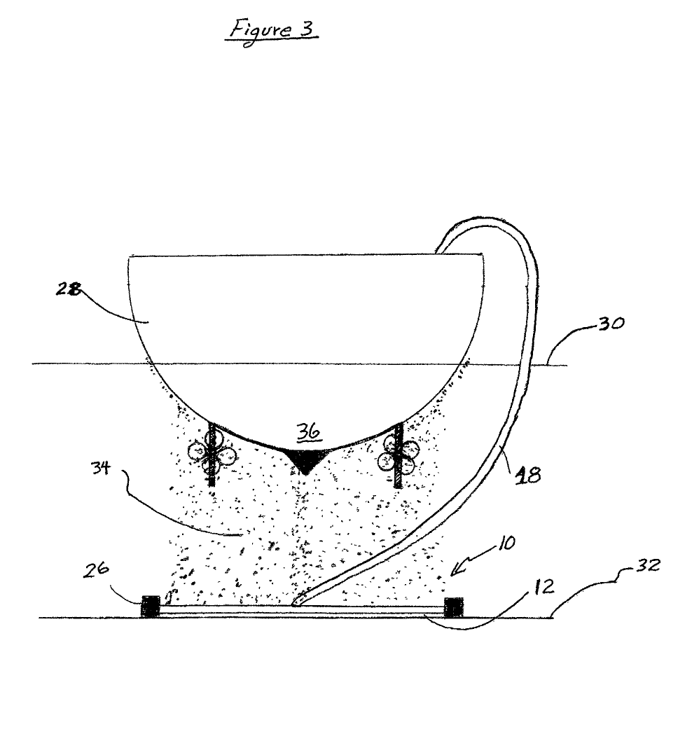

Turning to FIG. 3, shown therein is the rear view of a vessel 28 floating in a body of water 30 having the present invention 10 disposed proximately underneath the hull of the vessel so that the present invention 10 aerates the water in which the vessel 28 is situated. Shown therein is the framework 12 of the present invention 10 having a plurality of weights 26 which anchor the framework 12 to the bed 32 of the water body so that a stream of air bubbles 34 are continuously supplied to the hull area 36 of the vessel 28. Also shown is a conduit 18 which connects to the framework 12 and transmits air being supplied by an air source as previously disclosed.

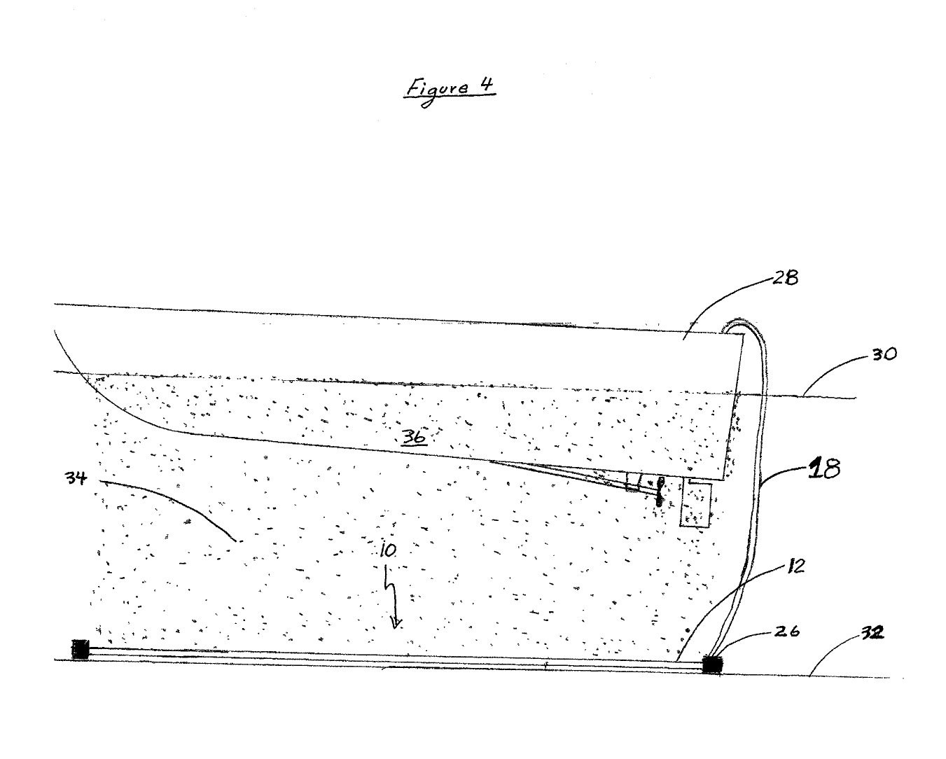

Turning to FIG. 4, shown therein is a side elevation view of a boat hull floating in a body of water 30 having the present invention 10 disposed proximately underneath the hull of the vessel so that the present invention 10 aerates the water in which the vessel 28 is situated. Shown therein is the framework 12 of the present invention 10 having a plurality of weights 26 which anchor the framework 12 to the bed 32 of the water body so that a stream of air bubbles 34 are continuously supplied to the hull area 36 of the vessel 28. Also shown is a conduit 18 which connects to the framework 12 and transmits air being supplied by an air source.

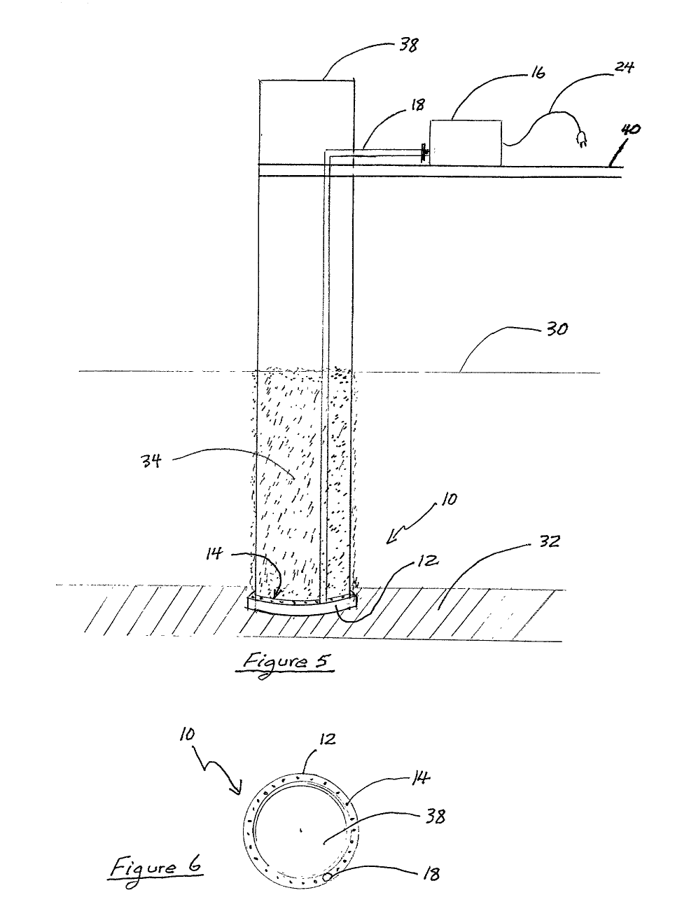

Turning to FIGS. 5 and 6, FIG. 5 shows a side elevation view of the present invention 10 in operative connection with the underwater structure 38 being a piling or leg member of an oil rig, or the like. FIG. 6 shows a plan view taken from FIG. 5 of the present invention 10 in operative connection with the structure 38. Shown in FIG. 5 are the present invention 10 disposed about the piling so that the framework 12 surrounds the structure 38 and is placed on the bed 32 of the water body having a plurality of aerators or air holes disposed and spaced about the framework 12 so that a plurality of air bubbles 34 are emitted from the framework 12 to rise upwardly proximate to the structure. Also shown is air supply 16, conduit 18 and electrical cord 20. Also shown is a pier 40 or other framework associated with a structure 38. FIG. 6 shows the present invention 10 having framework 12 surrounding the underwater structure 38 having multiple aerators along with conduit 18.

It is known in the art that underwater marine organisms will not grow on structures which are located in flowing or moving water. The aeration effect achieved by the present invention creates a water environment which is in constant movement thereby providing constant movement about the underwater structures being a piling or boat hull or the like which prevents marine organisms from growing on the underwater structure or boat hull. The present invention will also have a positive effect on the environment by reducing the use of toxic boat hull paints which are now in wide use and which are now used to prevent the growth of underwater marine organisms such as barnacles or the like. These paints are currently used on boat hulls as well as other underwater structures. Wide spread use of the present invention might include, for example, an entire boat marina having all boat slips connected up to a single large capacity air supply with a separate air valve being used to supply air to each boat slip whereby the boat user can simply turn his individual boat slip air supply off when the boat is not in its slip. Many other adaptations of the present invention will be accomplished by one skilled in the art without departing from the scope of the present invention.

What is claimed to be new and desired to be protected by Letters Patent is set forth in the appended claims:

1. A method for preventing the growth of underwater marine organisms on underwater structures, comprising the steps of:
a) providing a tubular framework having a plurality of air outlets therein;
b) supplying air to the tubular framework so that air is emitted from the plurality of air outlets; and,
c) placing the tubular framework in spatial relationship to an underwater structure effective for air bubbles from the air outlets to agitate the water column contiguous to the underwater structure so that growth of marine organisms is substantially prevented.

2. The method of claim 1, further comprising the step of shaping the tubular framework so that the framework provides air bubbles substantially about the entire surface of the underwater structure.

3. The method of claim 2, further comprising the step of placing the tubular framework substantially on the bed of the water body in which the underwater structure exists.

4. The method of claim 3, further comprising the steps of providing a continuous mechanical air supply and connecting the mechanical air supply to the tubular framework.

5. An apparatus for preventing the growth of underwater marine organisms on underwater structures, comprising:
a) a tubular framework, said framework having a plurality of spaced about air outlets therein so that air bubbles can be supplied about the underwater structure;
b) means for an air supply whereby air is supplied to the air outlets of the tubular framework so that air bubbles are emitted from the air outlets;
c) means for connecting said means for an air supply to said tubular framework; and,
d) means for anchoring said tubular framework proximate to the underwater structure whereby air bubbles from the air outlets agitate the water column contiguous to the underwater structure so that growth of marine organisms is substantially prevented.

6. The apparatus of claim 5, wherein said tubular framework is complementarily shaped as the underwater structure so that air bubbles agitate substantially the entire surface of the underwater structure.

7. The apparatus of claim 6, wherein said means for an air supply further comprises a mechanical air pump.

8. The apparatus of claim 7, wherein said means for connecting said means for an air supply to said tubular framework further comprises a conduit.

9. The apparatus of claim 8, wherein said means for anchoring said tubular framework further comprises weights spaced about and disposed upon said tubular framework.

10. The apparatus of claim 9, wherein said tubular framework further comprises polyvinyl chloride pipe.

11. The apparatus of claim 9, wherein said tubular framework further comprises acrylonitrile butadiene styrene pipe.
